(19) United States
(12) Patent Application Publication
(10) Pub. No.: US 2020/0109221 A1
(43) Pub. Date: Apr. 9, 2020

(54) HIGH MELT STRENGTH AMORPHOUS POLY ALPHA OLEFIN

(71) Applicant: REXtac, LLC, Odessa, TX (US)

(72) Inventors: Nick Fowler, Odessa, TX (US); Andres Sustic, Odessa, TX (US); John Passmore, Odessa, TX (US); John Joseph Decair, Odessa, TX (US)

(21) Appl. No.: 16/592,635

(22) Filed: Oct. 3, 2019

Related U.S. Application Data
(60) Provisional application No. 62/740,692, filed on Oct. 3, 2018.

(51) Int. Cl. C08F 10/00; C08J 3/24

(52) U.S. Cl. CPC C08F 10/00; C08F 2810/20; C08J 3/244

(57) ABSTRACT

A method to make a high melt strength amorphous poly alpha olefin (APAO) includes blending APAO with a free radical initiator using a residence time from 0.1 minutes to 10 minutes at a temperature range from 300 degrees Fahrenheit to 400 degrees Fahrenheit, thereby forming an intermediate. A graftable monomer may then be added to the intermediate in a ratio from 0.1:100 to 2:100 at a temperature range from 225 degrees Fahrenheit to 400 degrees Fahrenheit using a residence time from 0.1 to 20 minutes, thereby forming a functionalized APAO. A multifunctional monomer in an amount ranging from 0.1% to 5% by weight of the functionalized APAO can be added to the functionalized APAO for 0.1 to 20 minutes at 200 to 400 degrees Fahrenheit, thereby forming a cross-linkable APAO. An acid neutralizer may be added to initiate crosslinking, making a crosslinked APAO with various degrees of crosslinking as observed by the changes in the melt viscosity. An amine coupling agent may be added to the cross-linkable APAO to control crosslinking.

### CROSS REFERENCE TO RELATED APPLICATION

The present application claims priority to and the benefit of co-pending U.S. Provisional Patent Application Ser. No. 62/740,692, filed on Oct. 3, 2018 and titled “METHOD TO MAKE A HIGH MELT STRENGTH AMORPHOUS POLY ALPHA OLEFIN (APAO).” This reference is hereby incorporated in its entirety.

### FIELD

The present embodiment generally relates to a method to make a high melt strength amorphous poly alpha olefin (“APAO”).

### BACKGROUND

A need exists for a method to make a high melt strength amorphous poly alpha olefin with a low molecular weight.

The present embodiments may meet these needs.

### DETAILED DESCRIPTION OF THE EMBODIMENTS

Before explaining the present method in detail, it is to be understood that the method is not limited to the particular embodiments and can be practiced or carried out in various ways.

The following terms are used herein:

The term “amorphous poly alpha olefin” refers to polymers that are produced by the (co-)polymerization of α-olefins, for example, ethylene (CAS #74-85-1, wherein CAS refers to the Chemical Abstract Service), propylene (CAS #115-07-1), butene-1 (CAS #106-98-9) or hexene-1 (CAS #592-41-6), with Ziegler-Natta catalysts. The (co)-polymers have an amorphous structure which makes them useful for the production of hot melt adhesives.

In polymer chemistry, “cross-linking” may typically refer to the use of cross-links, or bonds, that link one polymer chain to another to promote a change in the polymers' physical properties.

The term “free radical” refers to an atom, molecule, and/or ion that has an unpaired valence electron. These unpaired electrons make free radicals highly chemically reactive.

One embodiment of the present disclosure relates to a method to make a high melt strength amorphous poly alpha olefin by first blending APAO with a free radical initiator using a residence time from 0.1 minutes to 10 minutes and a temperature range from 225 to 400 degrees Fahrenheit, thereby forming an intermediate.

According to some embodiments of the present disclosure, a graftable monomer is added to the above intermediate in monomer-to-intermediate ratios ranging from 0.1:100 to 2:100 at a temperature range from 225 to 400 degrees Fahrenheit using a residence time from 0.1 to 20 minutes, thereby forming a functionalized APAO.

Following forming the functionalized APAO, the embodiment includes adding, to the functionalized APAO, a multifunctional monomer in an amount ranging from 0.1 weight percent to 5 weight percent of the total weight of the functionalized APAO for 0.1 to 20 minutes at 225 to 400 degrees Fahrenheit, thereby forming a cross-linkable APAO.

An amine coupling agent and an acid neutralizer may then be added to the cross-linkable APAO to stop crosslinking, forming the high melt strength amorphous poly alpha olefin (APAO).

Embodiments of the present disclosure may reduce dependence on fossil fuels by using lower temperature reactions to form high melt strength amorphous poly alpha olefins.

The melt strength of a polymer may generally be increased by the addition of long-chain branches (“LCBs”) to the polymer's structure. Addition of LCBs can be achieved by several means involving chemical reactions. In some embodiments, methods of forming high melt strength amorphous poly alpha olefins (“HMS-APAO”) start by reacting APAO with an organic peroxide and maleic anhydride (“MAh”), to form maleated APAO. The maleated APAO is then reacted with a combination of acid neutralizers and optionally multi-functional monomers and amine coupling agents, resulting in high melt strength APAO. The subject matter product can be used either neat or as an additive to other APAOs, for such applications as building and construction, pavement and roofing modification, automotive interiors, and the like. HMS-APAO can even be used as a compatibilizer when blended with isotactic crystalline homo polypropylene, with random ethylene-co-propylene copolymers, and with impact polypropylene.

The present disclosure describes methods of making high melt strength APAO (“HMS-APAO”). Amorphous poly alpha olefin, APAO, is a low molecular weight, amorphous polymer of propylene or alternatively, a copolymer, or a terpolymer of propylene and ethylene monomer or of propylene and an alpha olefin monomer such as butene-1, hexene-1, octene-1, and/or other olefins having a size up to decene-1. Methods of making HMS-APAO include reacting APAO with an organic peroxide (a free radical initiator) and a graftable monomer such as maleic anhydride, resulting in the formation of functionalized (maleated) APAO. The high melt strength APAO formed according to the present disclosure may have improved performance and bondability to polar substrates and, due to the introduction of long-chain branches, improved melt strength. This maleation reaction may be made in the presence of some combination of amine coupling agents, acid neutralizers, and/or multi-functional monomers.

According to some embodiments of the present disclosure, the organic peroxide creates free radical sites on the polymer's chains from where a graftable anhydride monomer can attach with the resulting introduction of a polar, hydrolysable functional group. The use of multifunctional acrylate monomers, such as di- and tri-acrylates, is expected to control the breakdown in molecular weight of the polymer (vis-breaking), which may happen due to the instability of the free radical species generated by the reaction of the organic peroxide and the polymer. Reducing APAO vis-breaking during maleated APAO production may increase the number of potential long chain branches that can be formed when the HMS-APAO of the present disclosure includes coupling reactions and can be beneficial for long term performance of APAO-based ionomers upon neutralization. The addition of acid neutralizers (salts, optionally metallic salts), such as potassium hydroxide, sodium hydroxide, magnesium hydroxide, sodium bicarbonate, sodium acetate, zinc acetate, and other acid neutralizers, can yield an APAO ionomer. The polar groups may tend to congregate, thereby creating crosslinks throughout the polymer chain. At high temperatures, the attraction of the polar groups may be weakened. Thus, the crosslinks created by acid neutralization can be reversible, and it may be possible to increase the melt strength of APAO while retaining its thermoplastic character. The amine coupling agent can react with maleic anhydride when maleated APAO is used to form the HMS-APAO. However, neither the addition of the multifunctional acrylate nor the amine coupling agent is fundamentally necessary for all embodiments of the present disclosure.

Embodiments disclosed herein include the use of low molecular weight amorphous poly alpha olefins.

The multifunctional acrylate is hypothesized to interact with the APAO molecules while the free radicals are being generated by the organic peroxide and is thought to ameliorate the chain scission (vis-breaking) reaction during maleation. Traces of moisture or of water can hydrolyze the maleic anhydride groups, generating diacid moieties, and the metallic salts react with the carboxylic acids to form polyionomers. The coupling agents may also interact with the carboxylic acids of different chains to form bridges or crosslinks, to form the long chain branches that characterize a HMS-APAO.

According to embodiments of the present disclosure, a maleation reaction is initiated by the organic peroxide between the APAO and the graftable monomer, thereby leading to the initial formation of the maleated APAO.

### Prophetic Example 1—Batch Process

An exemplary method to make a high melt strength amorphous poly alpha olefin having a melt viscosity of 8000 centipoise (cps) at 375 degrees Fahrenheit is described.

As a first step, 8 pounds of the amorphous poly alpha olefin (APAO) is blended with 0.08 pounds of a free radical initiator known as azobisisobutyronitrile (AIBN), which is used to generate free radicals on the APAO molecules chains. The free radicals can be secondary and tertiary free radicals.

A residence time of 5 minutes is used at a temperature of 350 degrees Fahrenheit to form an intermediate.

Next, a graftable monomer is added to the intermediate. Maleic anhydride (MAh) is used in this example. The maleic anhydride is used in powder form.

The maleic anhydride is used in a ratio of 0.1:100 MAh to APAO.

A temperature of 350 degrees Fahrenheit is used with a residence time from 10 minutes forming a functionalized amorphous poly alpha olefin (APAO).

Next, 0.1 weight percent by weight of the multifunctional monomer pentaerythritol tetraacrylate (“PETA”) is added to the functionalized APAO.

Mixing then continues for a duration of 20 minutes at a temperature varying from 325 to 350 degrees Fahrenheit, forming a cross-linkable APAO. It is expected that the formed crosslinked poly alpha olefin has from 0.2% to 3% crosslinking.

Next, 0.5 weight percent of a blend of an amine coupling agent and an acid neutralizer is added to the formed crosslinkable poly alpha olefin. In this example, a blend of trimethylamine and potassium hydroxide is used.

The trimethylamine and potassium hydroxide are used in a ratio of 1:2 of the blend of amine coupling agent and acid neutralizer based on the total weight of the cross-linkable APAO to effect crosslinking forming the high melt strength low molecular weight APAO.

### Prophetic Example 2—Continuous Process

An exemplary method to make a high melt strength APAO having a melt viscosity of 3000 centipoise (cps) at 375 degrees Fahrenheit is described.

Amorphous poly alpha olefin (APAO) is flowed through a twin-screw extruder at a rate of 50 to 100 pounds per hour.

A free radical initiator known as TRIGONOX™ 101 is injected into the twin-screw extruder to generate free radicals. TRIGONOX™ 101 is made by AkzoNobel of Arnhem, The Netherlands. The free radicals formed on the APAO can be secondary and tertiary free radicals.

A residence time of 1 minute is used at a temperature of 375 degrees Fahrenheit, forming an intermediate.

As soon as the intermediate is formed, a graftable monomer is added to the intermediate. Itaconic anhydride is used in this example. The itaconic anhydride is used in molten form.

The itaconic anhydride is used in a ratio of 0.1:100 MAh to APAO

Next, 0.1 weight percent by weight of a multifunctional monomer of glycerol triacrylate is added to the functionalized amorphous poly alpha olefin (APAO).

Mixing then continues in the twin-screw extruder for a duration of 1 minutes at a temperature of 375 degrees Fahrenheit.

Next, 0.75 weight percent of a blend of an amine coupling agent and an acid neutralizer is injected into the continuous flow twin-screw extruder to form crosslinked poly alpha olefin. In this example, a blend of triethyl amine and zinc acetate is used.

The triethyl amine and zinc acetate are used in a ratio of 1:3 of the blend of amine coupling agent and acid neutralizer based on the total weight of the cross-linkable APAO to effect and control crosslinking, forming the high melt strength, low melt viscosity APAO.

### Prophetic Example 3—Batch Process

A method to make a high melt strength low melt viscosity amorphous poly alpha olefin (APAO) involves first blending 96 weight percent amorphous poly alpha olefin (APAO) with 4 weight percent of a graftable monomer namely maleic anhydride in a ratio of 96:4 of APAO to graftable monomer, at a temperature of 400 degrees Fahrenheit, forming a mixture.

1 weight percent a free radical initiator, namely TRIGONOX™ 101 peroxide is added to the mixture, to generate free radicals using a residence time of 5 minutes and a temperature of 400 degrees Fahrenheit forming a radicalized APAO.

### Prophetic Example 4—Batch Process

In this exemplary method, 3 weight percent of a multifunctional monomer, namely pentaerythritol tetraacrylate (PETA) is added to the mixture of Prophetic Example 3 for a duration of 10 minutes at a temperature of 400 degrees Fahrenheit prior to adding the free radical initiator.

### Prophetic Example 5—Batch Process

In this exemplary method, 0.5 weight percent of an acid neutralizer, namely potassium hydroxide, is added to maleated APAO of Prophetic Example 3, to effect crosslinking, forming a high melt strength low melt viscosity APAO.

### Prophetic Example 6—Continuous Process

A method to make a high melt strength low melt viscosity amorphous poly alpha olefin (APAO) comprises blending the APAO in a continuous process using a single or twin-screw extruder at a flow rate of 50 pounds per hour.

This method involves continuously blending amorphous poly alpha olefin (APAO) with a graftable monomer in a ratio of 100:1 of APAO to graftable monomer, at a temperature of 400 degrees Fahrenheit, while adding a free radical initiator to generate free radicals using a residence time of 1 minutes.

### Working Example 1—Intermediate

An intermediate was prepared by blending 200 grams of an APAO known as Rextac® RT 2115 grafted with 1.8% MAh in an aluminum one-pint can.

The intermediate was tested as having a melt viscosity of 945 cps, a needle penetration of 12 dmm, and a ring and ball softening point of 303 degrees Fahrenheit.

### Working Example 2—Batch Process

The intermediate from Working Example 1 was blended with 0.5 g potassium hydroxide for five minutes at a temperature of 375 degrees Fahrenheit after 1 mL of purified water was added dropwise to the intermediate.

The resulting sample was tested as having a melt viscosity of 1567 cps, a needle penetration of 11 dmm, and a ring and ball softening point of 301 degrees Fahrenheit.

### Working Example 3—Batch Process

The intermediate from Working Example 1 was blended with 1.5 g potassium hydroxide for twenty-five minutes at a temperature of 375 degrees Fahrenheit after 1 mL of purified water was added dropwise to the intermediate.

The resulting sample was tested as having a melt viscosity of 4375 cps, a needle penetration of 9 dmm, and a ring and ball softening point of 299 degrees Fahrenheit.

### Working Example 4—Batch Process

The intermediate from Working Example 1 was blended with 1.5 g sodium hydroxide for five minutes at a temperature of 375 degrees Fahrenheit after 1 mL of purified water was added dropwise to the intermediate.

The resulting sample was tested as having a melt viscosity of 1115 cps, a needle penetration of 11 dmm, and a ring and ball softening point of 303 degrees Fahrenheit.

### Working Example 5—Batch Process

The intermediate from Working Example 1 was blended with 1.0 g sodium hydroxide for five minutes at a temperature of 375 degrees Fahrenheit after 1 mL of purified water was added dropwise to the intermediate.

The resulting sample was tested as having a melt viscosity of 1055 cps, a needle penetration of 13 dmm, and a ring and ball softening point of 301 degrees Fahrenheit.

### Working Example 6—Batch Process

The intermediate from Working Example 1 was blended with 0.5 g sodium hydroxide for five minutes at a temperature of 375 degrees Fahrenheit after 1 mL of purified water was added dropwise to the intermediate.

The resulting sample was tested as having a melt viscosity of 1050 cps, a needle penetration of 14 dmm, and a ring and ball softening point of 301 degrees Fahrenheit.

### Working Example 7—Batch Process

The intermediate from Working Example 1 was blended with 2.0 g zinc acetate for five minutes at a temperature of 375 degrees Fahrenheit.

The resulting sample was tested as having a needle penetration of 16 dmm and a ring and ball softening point of 149 degrees Fahrenheit.

### Working Example 8—Batch Process

The intermediate from Working Example 1 was continuously blended with 2.0 g sodium hydroxide at a temperature of 375 degrees Fahrenheit.

The resulting sample was tested at 25 minutes as having a melt viscosity of 1415 cps, a needle penetration of 12 dmm, and a ring and ball softening point of 302 degrees Fahrenheit.

The resulting sample was tested at 35 minutes as having a melt viscosity of 1680 cps. The resulting sample was tested at 45 minutes as having a melt viscosity of 1800 cps. The resulting sample was tested at 60 minutes as having a melt viscosity of 2120 cps. The resulting sample was tested at 72 minutes as having a melt viscosity of 2400 cps. The resulting sample was tested at 82 minutes as having a melt viscosity of 2710 cps. The resulting sample was tested at 93 minutes as having a melt viscosity of 3360 cps. The resulting sample was tested at 110 minutes as having a melt viscosity of 4840 cps. The resulting sample was tested at 120 minutes as having a melt viscosity of 6710 cps.

### Working Example 9—Batch Process

The intermediate from Working Example 1 was blended with 2.0 g potassium hydroxide for twenty-five minutes at a temperature of 375 degrees Fahrenheit after 1 mL of purified water was added dropwise to the intermediate.

The resulting sample was tested as having a melt viscosity of 945 cps, a needle penetration of 12 dmm, and a ring and ball softening point of 303 degrees Fahrenheit.

While these embodiments have been described with emphasis on the embodiments, it should be understood that within the scope of the appended claims, the embodiments might be practiced other than as specifically described herein.

What is claimed is:

1. A method to make a high melt strength low melt viscosity amorphous poly alpha olefin comprising:
blending an amorphous poly alpha olefin with a free radical initiator to generate free radicals using a residence time from 0.1 minutes to 10 minutes at a temperature range from 225 degrees to 400 degrees Fahrenheit, thereby forming an intermediate;
adding a graftable monomer to the intermediate, in a ratio from 0.1:100 to 2:100 of the graftable monomer to the intermediate, at a temperature range from 225 degrees to 400 degrees Fahrenheit using a residence time from 0.1 minutes to 20 minutes, thereby forming a functionalized amorphous poly alpha olefin; and
adding from 0.1 weight percent to 5 weight percent by weight of a multifunctional monomer to the functionalized amorphous poly alpha olefin for a duration of 0.1 minutes to 30 minutes at a temperature from 225 degrees to 400 degrees Fahrenheit, thereby forming a crosslinked amorphous poly alpha olefin.

2. The method of claim 1, further comprising adding 0.1 weight percent to 5 weight percent of a blend of an amine coupling agent and an acid neutralizer, in a ratio of 0.1:1 to 1 to 1.1 of amine coupling agent to acid neutralizer, to the cross-linkable amorphous poly alpha olefin based on the total weight of the cross-linkable amorphous poly alpha olefin to effect the crosslinking reaction, thereby forming the high melt strength low melt viscosity amorphous poly alpha olefin.

3. The method of claim 2, wherein the acid neutralizer comprises potassium hydroxide, sodium hydroxide, sodium bicarbonate, sodium acetate, zinc acetate, or combinations thereof.

4. The method of claim 2, wherein the amine coupling agent comprises triethyl amine.

5. The method of claim 1, wherein the free radical initiator comprises an organic peroxide.

6. The method of claim 1, wherein the amorphous poly alpha olefin has a number average molecular weight from 5,000 Daltons to 20,000 Daltons.

7. The method of claim 1, wherein blending the amorphous poly alpha olefin further comprises blending the amorphous poly alpha olefin solely in a batch process using a double planetary mixer with heater under an inert gas selected from the group consisting of: argon, nitrogen, and mixtures comprising helium.

8. The method of claim 1, wherein blending the amorphous poly alpha olefin further comprises blending the amorphous poly alpha olefin in a continuous process using a single or twin-screw extruder at a flow rate of 50 pounds to 250 pounds per hour.

9. The method of claim 1, wherein the graftable monomer comprises maleic anhydride, itaconic anhydride, trimethoxy vinyl silane, triethoxy vinyl silane, or combinations thereof.

10. The method of claim 1, wherein the multifunctional monomer comprises diacrylates, triacrylates, tetraacrylates, or combinations thereof.

11. The method of claim 1, wherein the functionalized amorphous poly alpha olefin has an acid number of 1 to 40 and from 0.1% to 3% maleic anhydride per functionalized molecule of amorphous poly alpha olefin.

12. A method to make a high melt strength low melt viscosity amorphous poly alpha olefin comprising:
blending an amorphous poly alpha olefin with a graftable monomer, in a ratio of 100:0.1 to 100:2 of the amorphous poly alpha olefin to the graftable monomer, at a temperature range from 225 degrees to 400 degrees Fahrenheit, thereby forming a mixture and
adding, to the mixture, a free radical initiator to generate free radicals using a residence time from 0.1 minutes to 10 minutes and a temperature in the range from 225 degrees to 400 degrees Fahrenheit, thereby forming a maleated amorphous poly alpha olefin.

13. The method of claim 12, further comprising adding 0.1 weight percent to 1 weight percent of a multifunctional monomer to the mixture for a duration of 0.1 minutes to 30 minutes at a temperature from 225 degrees to 400 degrees Fahrenheit prior to adding the free radical initiator.

14. The method of claim 13, wherein the multifunctional monomer comprises diacrylates, triaacrylates, tetraacrylates, or combinations thereof.

15. The method of claim 12, further comprising adding an acid neutralizer having an amount of 0.1 weight percent to 2 weight percent of a total weight of the maleated amorphous poly alpha olefin, thereby crosslinking and forming a high melt strength low melt viscosity amorphous poly alpha olefin.

16. The method of claim 15, wherein the acid neutralizer comprises potassium hydroxide, sodium hydroxide, sodium bicarbonate, sodium acetate, zinc acetate, or combinations thereof.

17. The method of claim 12, wherein the free radical initiator comprises an organic peroxide.

18. The method of claim 12, wherein the amorphous poly alpha olefin has a number average molecular weight from 5,000 Daltons to 20,000 Daltons.

19. The method of claim 12, wherein blending the amorphous poly alpha olefin further comprises blending the amorphous poly alpha olefin in a continuous process using a single or twin-screw extruder at a flow rate of 50 pounds per hour to 250 pounds per hour.

20. The method of claim 12, wherein the graftable monomer comprises maleic anhydride, itaconic anhydride, trimethoxy vinyl silane, triethoxy vinyl silane, or combinations thereof.
